(19) United States
(12) Patent Application Publication
(10) Pub. No.: US 2025/0200339 A1
(43) Pub. Date: Jun. 19, 2025

(54) SENSOR DEVICE

(71) Applicant: SONY GROUP CORPORATION, TOKYO (JP)

(72) Inventor: KENJI SUZUKI, TOKYO (JP)

(21) Appl. No.: 18/849,544

(22) PCT Filed: Feb. 2, 2023
(86) PCT No.: PCT/JP2023/003462

§ 371 Date: Sep. 23, 2024

(30) Foreign Application Priority Data
Mar. 31, 2022 (JP) 2022-058008

(51) Int. Cl. G06N 3/0475

(52) U.S. Cl. CPC G06N 3/0475

(57) ABSTRACT

Provided is a sensor device that protects personal information included in sensor data. The sensor device is configured by mounting a sensor unit and a processing unit that anonymizes personal information included in sensor information acquired by the sensor unit in a single semiconductor device. The processing unit detects the personal information from the sensor information, identifies attribute information of the personal information, generates another person information having same attribute information, and replaces the personal information in the sensor information with the another person information. The processing unit uses a generative adversarial network to generate another person information that cannot be distinguished between true and false.

### TECHNICAL FIELD

The technology disclosed in this specification (hereinafter, “the present disclosure”) relates to a sensor device such as an image sensor that receives light from an object and converts the light into an electric signal.

### BACKGROUND ART

As mounting technology and the like improve, it becomes possible to manufacture small and high-performance sensor devices such as an image sensor at low cost, and the sensor devices has been widely used. On the other hand, sensor information sensed by sensor devices installed in various places may include personal information. For example, a captured image of a fixed point camera such as a monitoring camera installed in a store or a camera mounted on a mobile object such as an in-vehicle camera includes a face image of a pedestrian or the like, but the face image is personal information that can identify an individual. Therefore, how to collect sensor data while protecting personal information is a problem.

For example, there has been proposed an information processing device that generates an another person image having the same attribute information on the basis of attribute information estimated from a person image included in an image captured in a store and anonymizes a person (see Patent Document 1).

### CITATION LIST

### Patent Document

Patent Document 1: Japanese Patent Application Laid-Open No. 2020-91770
Patent Document 2: Japanese Patent No. 5773379

### Non-Patent Document

Non-Patent Document 1: Y. Viazovetskyi, V. Ivashkin, and E. Kashin, “StyleGAN2 Distillation for Feed-forward Image Manipulation”<URL: https://arxiv.org/abs/2003.03581>

### SUMMARY OF THE INVENTION

### Problems to be Solved by the Invention

An object of the present disclosure is to provide a sensor device that protects personal information included in sensor data.

### Solutions to Problems

The present disclosure has been made in view of the problems described above, and is a sensor device including:
a sensor unit; and
a processing unit that anonymizes personal information included in sensor information acquired by the sensor unit, in which
the sensor unit and the processing unit are mounted in a single semiconductor device.

The sensor device according to the present disclosure is specifically a stacked sensor having a multilayer structure in which the plurality of layers of semiconductor chips is stacked, the sensor unit being formed in a first layer and the processing unit being formed in a second layer or a layer further below the second layer. Then, the sensor device according to the present disclosure is configured to output sensor information after anonymization processing is performed by the processing unit.

The processing unit anonymizes the personal information by replacing the personal information included in the sensor information with information of an another person. Specifically, the processing unit detects the personal information from the sensor information, identifies attribute information of the personal information, generates another person information having same attribute information, and replaces the personal information in the sensor information with the another person information. At that time, the processing unit generates another person information using a generative adversarial network.

For example, in a case where the sensor unit is an image sensor, the processing unit identifies attribute information of a person image detected from image data, generates an another person image having same attribute information, and replaces the person image in the image data with the another person image.

### Effects of the Invention

According to the present disclosure, personal information included in sensor data is replaced with another personal information having the same attribute information, so that it is possible to provide a sensor device that protects the personal information by not outputting the sensor data to the outside with the original personal information as it is, and acquires data while maintaining quality without missing the attribute information or the like.

Note that, the effect described in the present specification is illustrative only and the effect by the present disclosure is not limited to this. Furthermore, there also is a case in which the present disclosure further has an additional effect in addition to the above-described effect.

Other objects, features, and advantages of the present disclosure will become apparent from more detailed description based on an embodiment that will be described later and the accompanying drawings.

### BRIEF DESCRIPTION OF DRAWINGS

FIG. 1 is a diagram illustrating a functional configuration example of an imaging device 100.

FIG. 2 is a diagram illustrating a hardware implementation example of an image sensor.

FIG. 3 is a diagram illustrating another hardware implementation example of the image sensor.

FIG. 4 is a diagram illustrating a configuration example of a stacked image sensor 400 having a two-layer structure.

FIG. 5 is a diagram illustrating a stacked image sensor 500 having a three-layer structure.

FIG. 6 is a diagram illustrating a configuration example of a sensor unit 102.

FIG. 7 is a diagram illustrating a functional configuration example of an image sensor 700.

FIG. 8 is a diagram illustrating a configuration example of a convolutional neural network.

FIG. 9 is a diagram in which a fully connected layer is simplified.

FIG. 10 is a diagram illustrating a functional configuration example for anonymizing image data.

FIG. 11 is a diagram illustrating another functional configuration example for anonymizing image data.

FIG. 12 is a diagram for explaining a GAN algorithm.

FIG. 13 is a flowchart illustrating a processing procedure for performing anonymization processing of image data.

FIG. 14 is a diagram illustrating a modification of FIG. 11.

FIG. 15 is a diagram illustrating a data collection system.

### MODE FOR CARRYING OUT THE INVENTION

Hereinafter, the present disclosure will be described in the following order with reference to the drawings.
A. Outline
B. Configuration of Sensor Device
C. Functional Configuration of Image Sensor
D. Anonymization of Image Data
D-1. First Configuration Example
D-2. Second Configuration Example
D-3. Generation of Another Person Image
D-4. Processing Procedure
D-5. Modification

### A. Outline

FIG. 15 schematically illustrates a configuration of a data collection system that collects a huge number of pieces of sensor data from sensor devices installed in various places in a server. The sensor device is a fixed point camera such as a monitoring camera installed in a store, an in-vehicle camera, a camera mounted on a mobile object (such as a drone) other than a vehicle, or the like. Since a small and high-performance sensor device such as an image sensor is manufactured at a low cost due to improvement in mounting technology and the like, a data collection system can be constructed at a relatively low cost. The data collection system collects enormous learning data necessary for machine learning such as a neural network model.

However, there is a case where the sensor information sensed by the sensor device includes personal information, and it is excessive to collect sensor data from each sensor device while protecting the personal information.

Patent Document 1 discloses a technique of taking an image captured by a digital camera into an information processing device such as a personal computer and anonymizing the image. In this case, an image in a state where personal information is not protected is output from the digital camera, and an operator (a user of a personal computer or the like) who performs anonymization can use the image in a state where personal information is not protected. If anonymization is performed by a personal computer before the captured image of the digital camera is uploaded to a server, there is a low possibility that the anonymization conflicts with the current laws on personal information protection in each country. However, when the image is output from the digital camera in a state where the personal information is not protected, there is a risk that the personal information of a person whose face is included in the image is protected only by the good will of the user who performs the anonymization work. If such handling of personal information becomes known on the Internet, for example, there is a risk of issues that criticisms and complaints intensively occur.

On the other hand, a sensor device to which the present disclosure is applied includes a circuit chip such as an image sensor, and is configured to output personal information included in sensor data to the outside after anonymizing the personal information. In other words, the sensor device to which the present disclosure is applied is configured not to output the sensor data to the outside of the circuit chip while the sensor device includes the personal information. Therefore, not only in a case where sensor data is directly uploaded from a sensor device to which the present disclosure is applied to a server, but also in a case where sensor data is uploaded to a server via an information processing device such as a personal computer, personal information included in original sensor data is not exposed to danger.

As anonymization of the person image included in the captured image of the camera, there is also processing of applying blindfold, mosaic, and blurring. However, in such simple anonymization, attribute information such as race, gender, and age of the original person is missing, and data quality is deteriorated. As a result, there arises a problem that it is not appropriate as learning data of machine learning. On the other hand, the sensor device to which the present disclosure is applied is configured to perform a face conversion process of replacing the person image included in the captured image with an another person image having the same attribute information as that of the person in the circuit chip and then output the image to the outside. Therefore, the sensor device to which the present disclosure is applied can supply the sensor data obtained by anonymizing the personal information while maintaining the quality without missing the attribute information or the like, and thus can be used as good learning data of machine learning.

### B. Configuration of Sensor Device

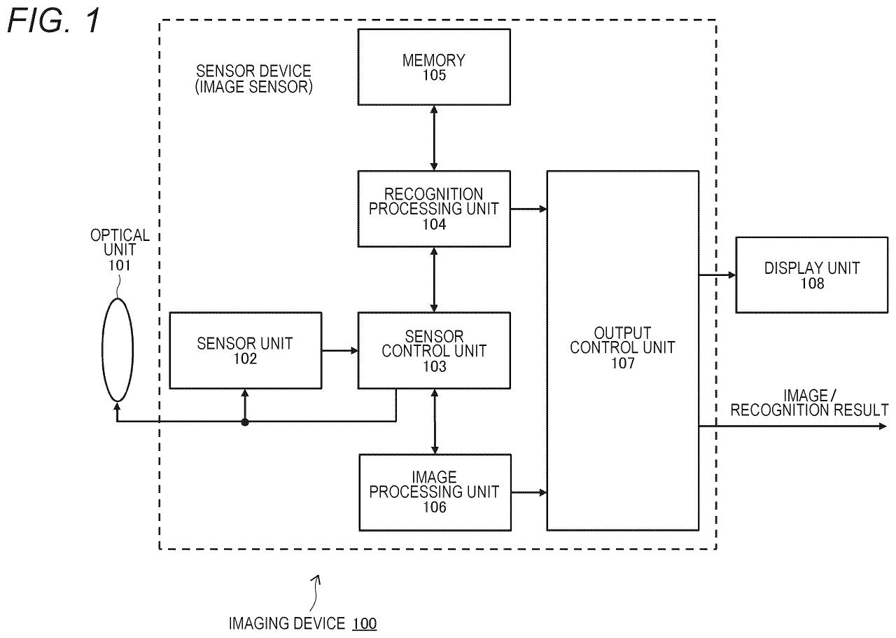

FIG. 1 illustrates a functional configuration example of an imaging device 100. The illustrated imaging device 100 includes an optical unit 101, a sensor unit 102, a sensor control unit 103, a recognition processing unit 104, a memory 105, an image processing unit 106, an output control unit 107, and a display unit 108. The imaging device 100 is a so-called digital camera or a device constituting a part of the digital camera. However, the imaging device 100 may be an infrared light sensor that captures an image with infrared light or other type of light sensor. Furthermore, among the components of the imaging device 100, the sensor unit 102, the sensor control unit 103, the recognition processing unit 104, the memory 105, the image processing unit 106, and the output control unit 107 surrounded by a dotted line can be integrated to form an image sensor including one complementary metal oxide semiconductor (CMOS) circuit chip using a CMOS. It should be understood that such an image sensor constitutes a sensor device to which the present disclosure is applied.

The optical unit 101 includes, for example, a plurality of optical lenses to condense light from a subject on a light receiving surface of the sensor unit 102, a diaphragm mechanism to adjust a size of an opening with respect to incident light, and a focus mechanism to adjust a focus of irradiation light on the light receiving surface. The optical unit 101 may further include a shutter mechanism that adjusts a time during which the light receiving surface is irradiated with light. The diaphragm mechanism, the focus mechanism, and the shutter mechanism included in the optical unit 101 are configured to be controlled by, for example, the sensor control unit 103. Note that the optical unit 101 may be configured integrally with the imaging device 100 or may be configured separately from the imaging device 100.

The sensor unit 102 includes a pixel array in which a plurality of pixels is arranged in a matrix. Each pixel includes a photoelectric conversion element, and a light receiving surface is formed by individual pixels arranged in a matrix. The optical unit 101 forms an image of incident light on the light receiving surface, and each pixel of the sensor unit 102 individually outputs a pixel signal corresponding to irradiation light. The sensor unit 102 further includes a drive circuit to drive each pixel included in the pixel array, and a signal processing circuit that performs predetermined signal processing on a signal read from each pixel and outputs the signal as a pixel signal of each pixel. The sensor unit 102 outputs a pixel signal of each pixel included in a pixel region, as digital image data.

The sensor control unit 103 controls reading of pixel data from each pixel of the sensor unit 102, and outputs image data based on each pixel signal read from each pixel. The pixel data outputted from the sensor control unit 103 is passed to the recognition processing unit 104 and the image processing unit 106. Furthermore, the sensor control unit 103 generates an imaging control signal for controlling imaging in the sensor unit 102, and supplies the imaging control signal to the sensor unit 102. The imaging control signal includes information indicating exposure and analog gain at the time of imaging in the sensor unit 102. The imaging control signal further includes a control signal for performing an imaging operation of the sensor unit 102, such as a vertical synchronization signal or a horizontal synchronization signal. Furthermore, the sensor control unit 103 generates a control signal for driving the diaphragm mechanism, the focus mechanism, and the shutter mechanism, and supplies the control signal to the optical unit 101.

On the basis of the pixel data delivered from the sensor control unit 103, the recognition processing unit 104 performs processing for recognizing an object in an image by the pixel data (person detection, face identification, image classification, etc.) and processing for protecting personal information included in the image data (anonymization processing or the like). However, the recognition processing unit 104 may perform the recognition processing by using image data after the image processing by the image processing unit 106. The recognition result obtained by the recognition processing unit 104 is passed to the output control unit 107. In the present embodiment, the recognition processing unit 104 performs processing such as recognition processing and anonymization processing (described later) on the image data using a learned machine learning model.

The image processing unit 106 performs, for example, signal processing such as black level correction to regard a black level of the digital image signal as a reference black level, white balance control to correct red and blue levels such that a white part of the subject is correctly displayed and recorded as white, and gamma correction to correct a grayscale characteristic of the image signal. Furthermore, the image processing unit 106 can instruct the sensor control unit 103 to read pixel data necessary for the image processing from the sensor unit 102. The image processing unit 106 passes the image data in which the pixel data has been processed, to the output control unit 107.

To the output control unit 107, a recognition result of an object included in an image is passed from the recognition processing unit 104, and image data as an image processing result is passed from the image processing unit 106, and the output control unit 107 outputs one or both of them to the outside of the imaging device 100. Furthermore, the output control unit 107 outputs the image data to the display unit 108. The user can visually recognize a display image on the display unit 108. The display unit 108 may be built in the imaging device 100 or may be externally connected to the imaging device 100.

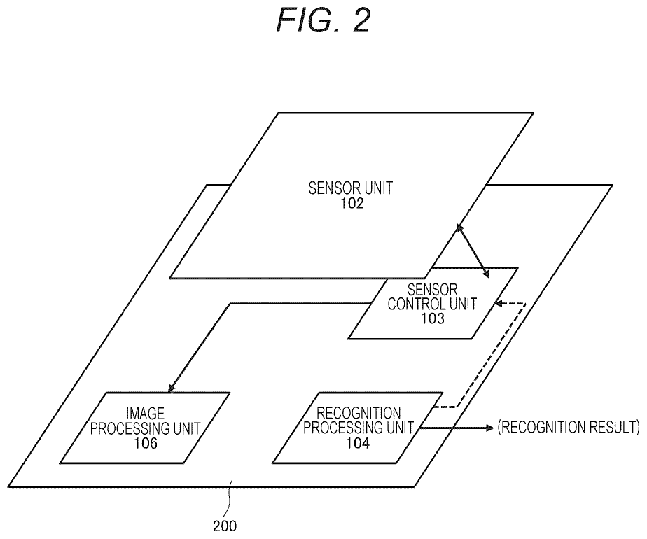

FIG. 2 illustrates a hardware implementation example of an image sensor used in the imaging device 100. In the example illustrated in FIG. 2, the sensor unit 102, the sensor control unit 103, the recognition processing unit 104, the memory 105, the image processing unit 106, and the output control unit 107 are mounted on one chip 200. However, in FIG. 2, illustration of the memory 105 and the output control unit 107 is omitted in order to prevent confusion of the drawing. In the configuration example illustrated in FIG. 2, a recognition result obtained by the recognition processing unit 104 is outputted to the outside of the chip 200 via the output control unit 107. Furthermore, the recognition processing unit 104 can acquire pixel data or image data to be used for recognition, from the sensor control unit 103 via an interface inside the chip 200.

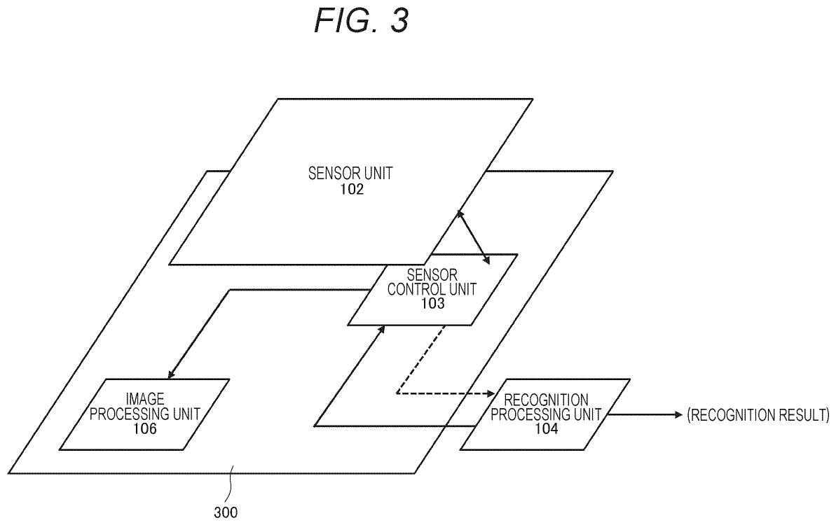

FIG. 3 illustrates another hardware implementation example of the image sensor used in the imaging device 100. In the example illustrated in FIG. 3, the sensor unit 102, the sensor control unit 103, the image processing unit 106, and the output control unit 107 are mounted on one chip 300, but the recognition processing unit 104 and the memory 105 are arranged outside the chip 300. However, also in FIG. 3, illustration of the memory 105 and the output control unit 107 is omitted in order to prevent confusion of the drawing. In the configuration example illustrated in FIG. 3, the recognition processing unit 104 acquires pixel data or image data to be used for recognition, from the output control unit 107 via a communication interface between chips. Furthermore, the recognition processing unit 104 directly outputs the recognition result to outside. Of course, a configuration may be adopted in which the recognition result obtained by the recognition processing unit 104 is returned to the output control unit 107 in the chip 300 via a communication interface between chips, and is outputted from the output control unit 107 to the outside of the chip 300.

In the image sensor of the configuration example illustrated in FIG. 2, since both the recognition processing unit 104 and the sensor control unit 103 are mounted on the same chip 200, communication between the recognition processing unit 104 and the sensor control unit 103 can be executed at high speed via the interface in the chip 200. On the other hand, in the image sensor of the configuration example illustrated in FIG. 3, since the recognition processing unit 104 is arranged outside the chip 300, replacement of the recognition processing unit 104 is easy. However, it is necessary to perform communication between the recognition processing unit 104 and the sensor control unit 103 via an interface between chips, which lowers the speed.

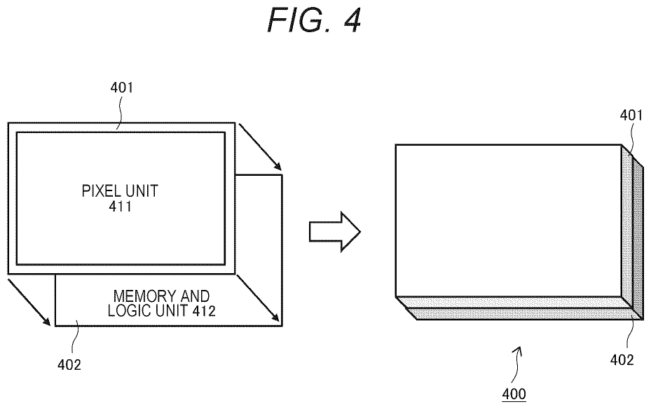

FIG. 4 illustrates an example in which the semiconductor chip 200 (or 300) of the image sensor used in the imaging device 100 is formed as a stacked image sensor 400 having a two-layer structure in which two layers are stacked. In the illustrated structure, a pixel unit 411 is formed in a semiconductor chip 401 of a first layer, and a memory and logic unit 412 is formed in a semiconductor chip 402 of a second layer.

The pixel unit 411 includes at least a pixel array in the sensor unit 102. Furthermore, the memory and logic unit 412 includes, for example, the sensor control unit 103, the recognition processing unit 104, the memory 105, the image processing unit 106, the output control unit 107, and an interface that performs communication between the imaging device 100 and outside. The memory and logic unit 412 further includes a part or all of a drive circuit that drives the pixel array in the sensor unit 102. Furthermore, although not illustrated in FIG. 4, the memory and logic unit 412 may further include, for example, a memory used by the image processing unit 106 for processing image data. As illustrated on the right side of FIG. 4, the semiconductor chip 401 of the first layer and the semiconductor chip 402 of the second layer are bonded to each other while being in electrical contact with each other, so that an image sensor in which the sensor control unit 103, the recognition processing unit 104, the memory 105, the image processing unit 106, and the output control unit 107 are integrated is configured on the same semiconductor chip as a solid-state imaging element.

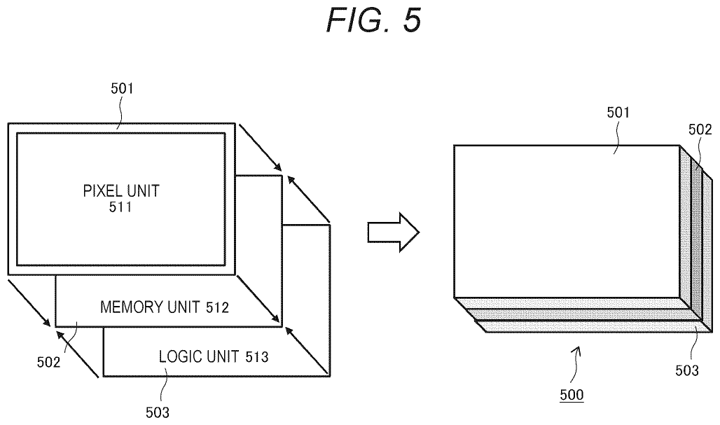

FIG. 5 illustrates an example in which the semiconductor chip 200 (or 300) of the image sensor used in the imaging device 100 is formed as a stacked image sensor 500 having a three-layer structure in which three layers are stacked. In the illustrated structure, a pixel unit 511 is formed in a semiconductor chip 501 of a first layer, a memory unit 512 is formed in a semiconductor chip 502 of a second layer, and a logic unit 513 is formed in a semiconductor chip 503 of a third layer.

The pixel unit 511 includes at least a pixel array in the sensor unit 102. Furthermore, the logic unit 513 includes, for example, the sensor control unit 103, the recognition processing unit 104, the image processing unit 106, the output control unit 107, and an interface that performs communication between the imaging device 100 and outside. The logic unit 513 further includes a part or all of a drive circuit that drives the pixel array in the sensor unit 102. Furthermore, in addition to the memory 105, the memory unit 512 may further include, for example, a memory used by the image processing unit 106 for processing image data. As illustrated on the right side of FIG. 5, the semiconductor chip 501 of the first layer, the semiconductor chip 502 of the second layer, and the semiconductor chip 503 of the third layer are bonded to each other while being in electrical contact with each other, so that an image sensor in which the sensor control unit 103, the recognition processing unit 104, the memory 105, the image processing unit 106, and the output control unit 107 are integrated is configured on the same semiconductor chip as a solid-state imaging element.

Note that, in the present specification, only a stacked image sensor having a two-layer structure and a three-layer structure is described, but a stacked image sensor having a multilayer structure of four or more layers may of course be used. Specifically, the stacked image sensor illustrated in FIGS. 4 and 5 is a single semiconductor device in which the pixel unit and the signal processing circuit unit are formed on separate silicon substrates (semiconductor chips), the silicon substrates are aligned and bonded with high accuracy, and then the silicon substrates are electrically connected at multiple points (see, for example, Patent Document 2). Such a stacked image sensor can secure a wide signal processing region immediately below the pixel unit, and can achieve both an increase in circuit scale due to multifunctionalization and downsizing of the structure. The stacked image sensor can be equipped with a function such as artificial intelligence (for example, a machine learning model such as a neural network).

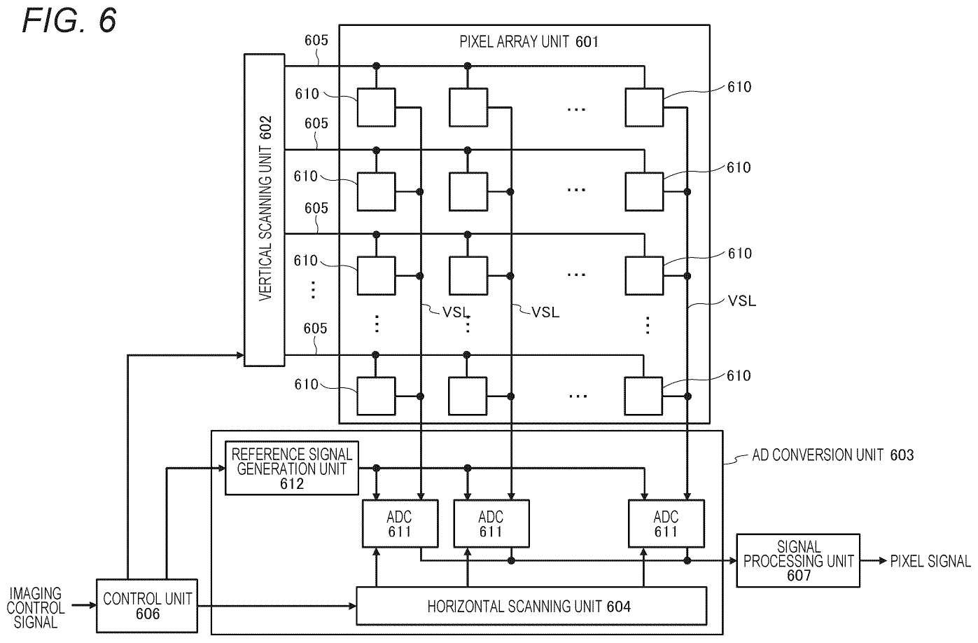

FIG. 6 illustrates a configuration example of the sensor unit 102. The illustrated sensor unit 102 corresponds to the pixel unit 411 in FIG. 4 or the pixel unit 511 in FIG. 5, and is assumed to be formed in the first layer of the multilayer stacked image sensor. The sensor unit 102 includes a pixel array unit 601, a vertical scanning unit 602, an analog to digital (AD) conversion unit (ADC) 603, a horizontal scanning unit 604, a pixel signal line 605, a vertical signal line VSL, a control unit 606, and a signal processing unit 607. Note that the control unit 606 and the signal processing unit 607 in FIG. 6 may be included in the sensor control unit 103 in FIG. 1, for example.

The pixel array unit 601 includes a plurality of pixel circuits 610 each including a photoelectric conversion element that performs photoelectric conversion on received light and a circuit that reads electric charge from the photoelectric conversion element. The plurality of pixel circuits 610 is arranged in a matrix in a horizontal direction (a row direction) and a vertical direction (a column direction). The arrangement of the pixel circuits 610 in the row direction is a line. For example, in a case where an image of one frame is formed with 1920 pixels×1080 lines, the pixel array unit 601 forms an image of one frame by pixel signals obtained by reading 1080 lines each including 1920 pieces of the pixel circuit 610.

In the pixel array unit 601, the pixel signal line 605 is connected to each row and the vertical signal line VSL is connected to each column, for the row and the column of each pixel circuit 610. An end portion of each pixel signal 605 not connected to the pixel array unit 601 is connected to the vertical scanning unit 602. Under the control of the control unit 606, the vertical scanning unit 602 transmits a control signal such as a drive pulse at the time of reading a pixel signal from a pixel, to the pixel array unit 601 via the pixel signal line 605. An end portion of the vertical signal line VSL not connected to the pixel array unit 601 is connected to the AD conversion unit 603. The pixel signal read from the pixel is transmitted to the AD conversion unit 603 via the vertical scanning line VSL.

Reading of the pixel signal from the pixel circuit 610 is performed by transferring electric charge accumulated in the photoelectric conversion element by exposure to a floating diffusion (FD) layer, and converting the electric charge transferred in the floating diffusion layer into a voltage. A voltage converted from the electric charge in the floating diffusion layer is outputted to the vertical signal line VSL via an amplifier (not illustrated in FIG. 6).

The AD conversion unit 603 includes an AD converter 611 provided for each vertical signal line VSL, a reference signal generation unit 612, and the horizontal scanning unit 604. The AD converter 611 is a column AD converter that performs AD conversion processing on each column of the pixel array unit 601, and the AD converter 611 performs AD conversion processing on a pixel signal supplied from the pixel circuit 610 via the vertical signal line VSL to generate two digital values for correlated double sampling (CDS) processing for performing noise reduction, and outputs the digital values to the signal processing unit 607.

The reference signal generation unit 612 generates, as a reference signal, a ramp signal to be used by the AD converter 611 of each column to convert a pixel signal into two digital values on the basis of a control signal from the control unit 606, and supplies the ramp signal to the AD converter 611 of each column. The ramp signal is a signal in which a voltage level decreases at a constant slope with respect to time, or a signal in which the voltage level decreases stepwise.

In the AD converter 611, when the ramp signal is supplied, counting is started by the counter according to the clock signal, the voltage of the pixel signal supplied from the vertical signal line VSL is compared with the voltage of the ramp signal, the counting by the counter is stopped at the timing when the voltage of the ramp signal exceeds the voltage of the pixel signal, and a value corresponding to the count value at that time is output, so that the pixel signal that is an analog signal is converted into a digital value.

The signal processing unit 607 performs CDS processing on the basis of the two digital values generated by the AD converter 611, generates a pixel signal (pixel data) of a digital signal, and outputs the pixel signal to the outside of the sensor control unit 103.

The horizontal scanning unit 604 sequentially outputs digital values temporarily held by the individual column AD converters 611 to the signal processing unit 607, by performing a selection operation to select the individual column AD converters 611 in a predetermined order under the control of the control unit 606. The horizontal scanning unit 604 is configured using, for example, a shift register, an address decoder, and the like.

The control unit 606 generates a drive signal for controlling driving of the vertical scanning unit 602, the AD conversion unit 603, the reference signal generation unit 612, the horizontal scanning unit 604, and the like on the basis of an imaging control signal supplied from the sensor control unit 103, and outputs the drive signal to each unit. For example, the control unit 606 generates a control signal for the vertical scanning unit 602 to supply to each pixel circuit 610 via the pixel signal line 605 on the basis of a vertical synchronization signal and a horizontal synchronization signal included in the imaging control signal, and supplies the control signal to the vertical scanning unit 602. Furthermore, the control unit 606 passes information indicating analog gain included in the imaging control signal, to the AD conversion unit 603. In the AD conversion unit 603, gain of a pixel signal inputted to each AD converter 611 via the vertical signal line VSL is controlled on the basis of the information indicating the analog gain.

On the basis of the control signal supplied from the control unit 606, the vertical scanning unit 602 supplies various signals including a drive pulse in the pixel signal line 605 of the selected pixel row of the pixel array unit 601 to each pixel circuit 610 for each line, and controls to output the pixel signal from each pixel circuit 610 to the vertical signal line VSL. The vertical scanning unit 602 is configured using, for example, a shift register, an address decoder, and the like. Furthermore, the vertical scanning unit 602 controls exposure in each pixel circuit 610 on the basis of information indicating exposure and supplied from the control unit 606.

The sensor unit 102 configured as illustrated in FIG. 6 is a column AD type image sensor in which each AD converter 611 is arranged for each column.

Examples of an imaging method when imaging is performed by the pixel array unit 601 include a rolling shutter method and a global shutter method. In the global shutter method, all the pixels of the pixel array unit 601 are simultaneously exposed and pixel signals are collectively read. On the other hand, in the rolling shutter method, the exposure is sequentially performed line by line from top to bottom of the pixel array unit 601 to read the pixel signal.

Note that “imaging” refers to an operation in which the sensor unit 102 outputs a pixel signal corresponding to light emitted to the light receiving surface, but specifically refers to a series of operations up to exposure in a pixel and transfer of a pixel signal based on electric charges accumulated by exposure in a photoelectric conversion element included in the pixel to the sensor control unit 102. Furthermore, the frame indicates a region in which the effective pixel circuit 610 for generating the pixel signal is arranged in the pixel array unit 601.

### C. Functional Configuration of Image Sensor

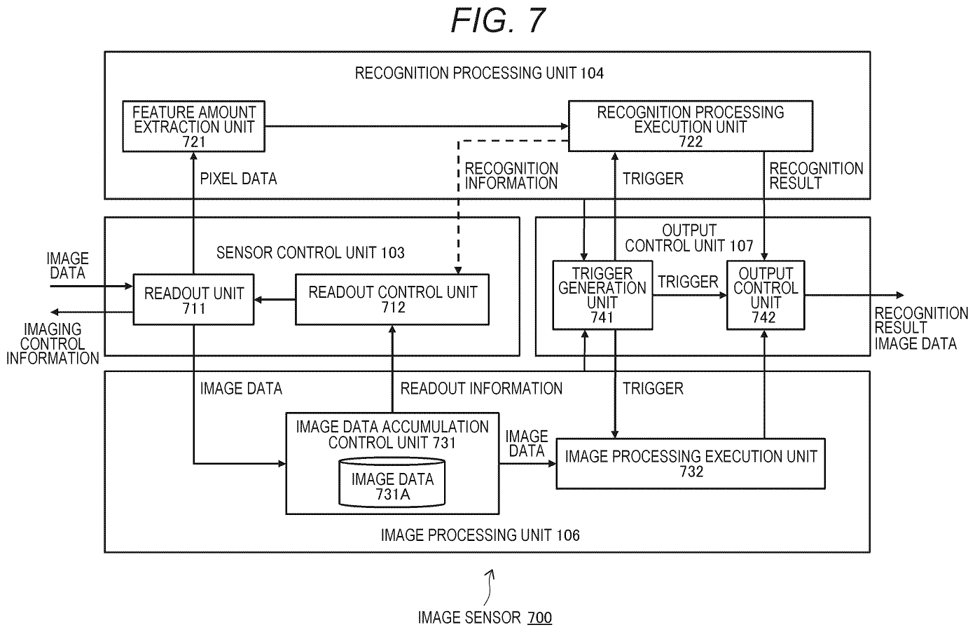

FIG. 7 illustrates a functional configuration example of an image sensor 700. The image sensor 700 includes a sensor unit 102, a sensor control unit 103, a recognition processing unit 104, a memory 105, an image processing unit 106, and an output control unit 107 among the components of the imaging device 100 illustrated in FIG. 1, and is configured as a stacked image sensor (see, for example, FIGS. 4 and 5) having a multilayer structure in which these functional modules are stacked in a plurality of layers. FIG. 7 illustrates the image sensor 700 assuming a case where a machine learning model is mounted on the recognition processing unit 104, but the sensor unit 102 is omitted for convenience. Furthermore, in the following description, which layer of the semiconductor chip among the plurality of layers each functional module is formed on is not particularly limited.

The sensor control unit 103 includes a readout unit 711 and a readout control unit 712. The readout control unit 712 controls an operation of reading the pixel data from the sensor unit 102 by the readout unit 711. The readout control unit 712 controls a readout timing and a readout speed (a frame rate of a moving image) of pixel data. Furthermore, in a case where the information indicating the exposure and the analog gain can be received from the recognition processing unit 104, the image processing unit 106, or the like, the received information indicating the exposure and the analog gain is passed to the readout unit 711. Then, the readout unit 711 reads the pixel data from the sensor unit 102 on the basis of an instruction from the readout control unit 712. The readout unit 711 generates imaging control information such as a vertical synchronization signal and a horizontal synchronization signal, and supplies the imaging control information to the sensor unit 102. Furthermore, in a case where information indicating the exposure and the analog gain is passed from the readout control unit 712, the readout unit 711 sets the exposure and the analog gain for the sensor unit 102. Then, the readout unit 711 passes the pixel data acquired from the sensor unit 102 to the recognition processing unit 104 and the image processing unit 106.

The recognition processing unit 104 is equipped with a convolutional neural network (CNN) as a machine learning model, and includes a feature amount extraction unit 721 and a recognition processing execution unit 722. However, it is assumed that the machine learning model has been learned.

The feature amount extraction unit 721 calculates an image feature amount from the pixel data transferred from the readout unit 711. Furthermore, the feature amount extraction unit 721 may acquire information for setting the exposure and the analog gain from the readout unit 711, and calculate the image feature amount by further using the acquired information.

The recognition processing execution unit 722 corresponds to a discriminator in a convolutional neural network, and executes, for example, object detection, person detection (face detection), person identification (face identification), and the like as recognition processing on the basis of the image feature amount calculated by the feature amount extraction unit 721. Then, the recognition processing execution unit 722 outputs such a recognition result to an output control execution unit 742. The recognition processing execution unit 722 can execute the recognition processing by inputting the image feature amount from the feature amount extraction unit 721 using the trigger generated by a trigger generation unit 741 as a trigger.

Note that the recognition processing execution unit 722 may output information (recognition information) regarding a recognition result or a recognition situation of the recognition processing unit 104, such as likelihood, reliability, or a recognition error of the output label, to the sensor control unit 103. On the other hand, the readout control unit 712 may control the readout timing and the readout speed (the frame rate of the moving image) of the pixel data according to the recognition processing result or the recognition situation in the recognition processing unit 104.

The image processing unit 106 includes an image data accumulation control unit 731 and an image processing execution unit 732.

The image data accumulation control unit 731 generates image data for the image processing execution unit 732 to perform image processing on the basis of the pixel data passed from the readout unit 711. The image accumulation control unit 731 may pass the generated image data to the image processing execution unit 732 as it is or temporarily accumulate the generated image data in an image accumulation unit 731A. The image accumulation unit 731A may be the memory 105 or another memory area formed on the same semiconductor chip. Furthermore, the image accumulation control unit 731 may acquire information for setting the exposure and the analog gain from the readout unit 711, and accumulate the acquired information in the image accumulation unit 731A.

The image processing execution unit 732 performs, for example, signal processing such as black level correction to regard a black level of the digital image signal as a reference black level, white balance control to correct red and blue levels such that a white part of the subject is correctly displayed and recorded as white, and gamma correction to correct a grayscale characteristic of the image signal. Then, the image processing execution unit 732 outputs the processed image data to the output control execution unit 742. The image processing execution unit 732 can receive image data from the image data accumulation control unit 731 and execute image processing on the basis of the trigger generated by the trigger generation unit 741.

The output control unit 107 performs control to output one or both of the recognition result delivered from the recognition processing unit 104 and the image data delivered from the image processing unit 106 to the outside of the image sensor. The output control unit 107 includes a trigger generation unit 741 and an output control execution unit 742.

The trigger generation unit 741 generates a trigger to be passed to the recognition processing execution unit 722, a trigger to be passed to the image processing execution unit 732, and a trigger to be passed to the output control execution unit 742 on the basis of the information regarding the recognition result passed from the recognition processing unit 104 and the information regarding the image processing result passed from the image processing unit 106. Then, the trigger generation unit 741 supplies the generated triggers to the recognition processing execution unit 722, the image processing execution unit 732, and the output control execution unit 742 at predetermined timings.

The output control execution unit 742 outputs one or both of the recognition result delivered from the recognition processing unit 104 and the image data delivered from the image processing unit 106 to the outside of the image sensor by using the trigger generated by the trigger generation unit 741 as a trigger.

Note that, although FIG. 7 illustrates an example in which only one CNN is mounted in the recognition processing unit 104 for the sake of simplicity, a plurality of CNNs may be mounted. In a case where a plurality of CNNs is mounted, the CNNs may be arranged in series, or at least some of the CNNs may be arranged in parallel. Furthermore, in the example illustrated in FIG. 7, the pixel data read from the sensor unit 102 is input to the CNN in the recognition processing unit 104, but image data processed by the image processing unit 106 may be input to the CNN. Furthermore, the processing result of the recognition processing unit 104 may be output to the image processing unit 106 in addition to being output to the outside of the image sensor, and the image processing unit 106 may perform image processing based on the recognition result. Furthermore, a CNN may be mounted not only in the recognition processing unit 104 but also in the image processing unit 106.

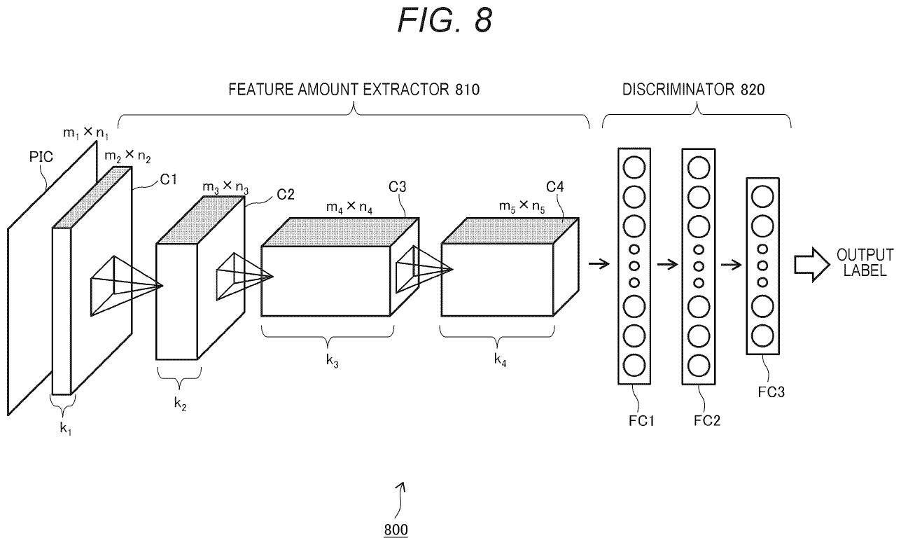

FIG. 8 illustrates a configuration example of a convolutional neural network (CNN) 800 mounted on the recognition processing unit 104 and the like. The illustrated convolutional neural network 800 is configured by a feature amount extractor 810 including a plurality of convolutional layers and pooling layers and a discriminator 820 which is a neural network (fully connected layer). The feature amount extractor 810 and the discriminator 820 correspond to the feature amount extraction unit 721 and the recognition processing execution unit 722 in the recognition processing unit 104 illustrated in FIG. 7, respectively.

In the feature amount extractor 810 in a previous stage of the discriminator 820, a feature of the input image is extracted by the convolutional layers and the pooling layers. In each convolution layer, a local filter that extracts a feature of an image is applied to an input image while being moved, and the feature is extracted from the input image. Furthermore, each pooling layer compresses an image feature input from the most recent convolution layer.

The feature amount extractor 810 includes four stages of convolutional layers and pooling layers. Assuming that a first-stage convolutional layer C1, a second-stage convolutional layer C2, a third-stage convolutional layer C3, and a fourth-stage convolutional layer C4 are used from a side closer to an input image PIC, resolution of processed images is smaller and the number of feature maps (number of channels) is larger in later stages. More specifically, assuming that resolution of the input image PIC is m₁×n₁, resolution of the first-stage convolutional layer C1 is m₂×n₂, resolution of the second-stage convolutional layer C2 is m₃×n₃, resolution of the third-stage convolutional layer C3 is m₄×n₄, and resolution of the fourth-stage convolutional layer C4 is m₅×n₅ (m₁×n₁<m₂×n₂≤m₃×n₃≤m₄×n₄≤m₅×n₅). Furthermore, the number of feature maps of the first-stage convolutional layer C1 is k₁, the number of feature maps of the second-stage convolutional layer C2 is k₂, the number of feature maps of the third-stage convolutional layer C3 is k₃, and the number of feature maps of the fourth-stage convolutional layer C4 is k₄(k₁≤k₂≤k₃≤k₄, but k₁ to k₄ are not the same). Note that illustration of the pooling layers is omitted in FIG. 8.

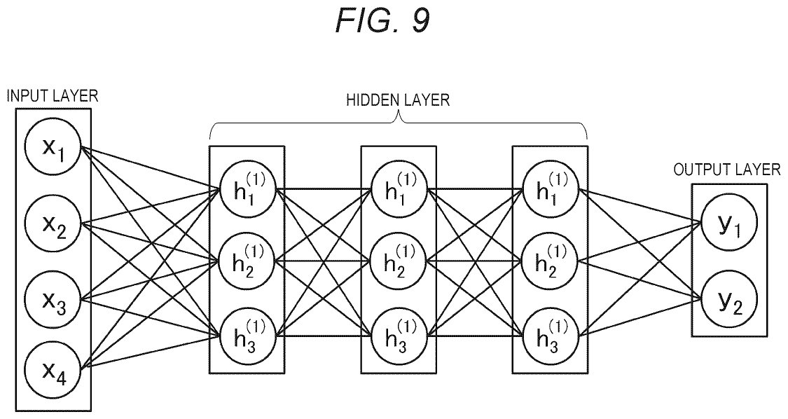

The discriminator 820 is configured by an input layer FC1, one or more hidden layers FC2, and an output layer FC3, and includes a fully connected layer in which all nodes of each layer are connected with all nodes of the subsequent layer. The outputs of the fourth-stage convolutional layer C4 of the feature extractor 310 are arranged one-dimensionally and used as inputs to the fully connected layer. For simplification of the description, if the fully connected layer is simplified as illustrated in FIG. 9 (the hidden layer is three layers), for example, the connected portion between the input layer and the first hidden layer is expressed by the following Expression (1). Connected portions of other layers are similarly represented.

$$\begin{matrix}[ Math . 1 ] & \\ {h}_{j}^{( 1 )} = {w}_{1} {x}_{1} + {w}_{2} {x}_{2} + {w}_{3} {x}_{3} + {w}_{4} {x}_{4} & ( 1 )\end{matrix}$$

y₁ and y₂ of the output layer in FIG. 9 correspond to the output labels output from the convolutional neural network. Furthermore, coefficients W₁, W₂, W₃, and W₄ in the above Expression (1) are coupling weights of connected portions between corresponding nodes. In the learning phase of the convolutional neural network, the weighting coefficients W₁, W₂, W₃, W₄, . . . are updated by a learning algorithm such as error back propagation so that the correct answer label y is output for the input data x.

Note that the machine learning model is a function approximator capable of learning an input/output relationship, but the machine learning model installed in the recognition processing unit 104 is not limited to a neural network, and may be, for example, a support vector machine, a Gaussian process regression model, or the like.

### D. Anonymization of Image Data

The image data captured from the sensor unit 102 and processed by the image processing unit 106 can include personal information such as a person image. Therefore, if the image data processed by the image processing unit 106 is output as it is to the outside of the image sensor, the personal information of the person whose face is included in the image is exposed to danger.

Therefore, in the present embodiment, the personal information included in the image data read from the sensor unit 102 is anonymized in the image sensor and then output to the outside of the image sensor. That is, the image sensor including the circuit chip is configured not to output the image data to the outside of the circuit chip in a state where the image data includes the personal information. Therefore, even in a case where the image sensor is used for a fixed point camera, an in-vehicle camera, or the like, or even in a case where the image data captured by the image sensor is directly uploaded to a server or taken into a personal computer, personal information included in original image data is not exposed to danger.

### D-1. First Configuration Example

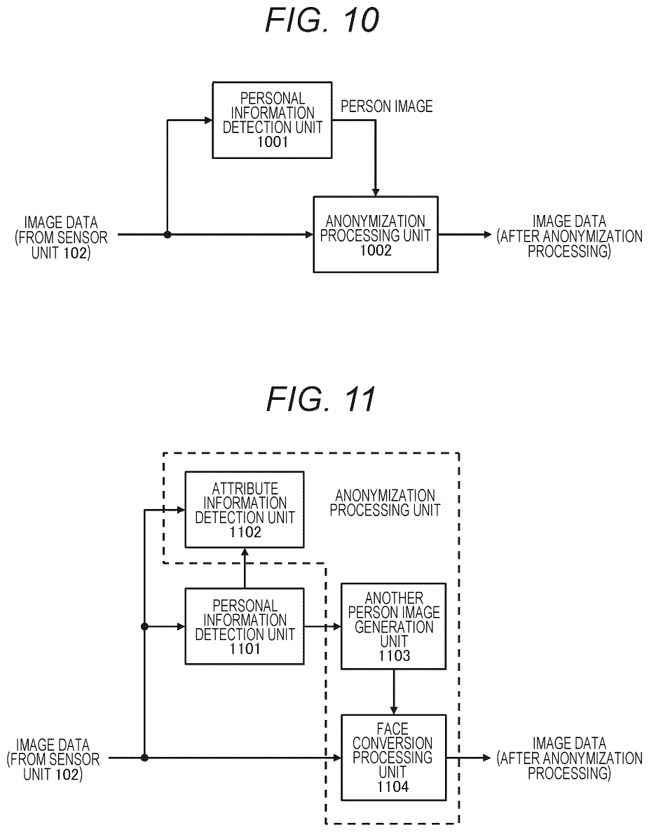

FIG. 10 illustrates a functional configuration example for anonymizing personal information in image data. In the example illustrated in FIG. 10, anonymization processing is performed on the personal information in the image data by a personal information detection unit 1001 and an anonymization processing unit 1002.

When capturing the image data from the sensor unit 102 via the readout unit 711 (described above), the personal information detection unit 1001 detects the person image as the personal information included in the image data. Then, the anonymization processing unit 1002 performs image processing on the personal information included in the original image data so that the personal information cannot be specified.

In this way, by anonymizing the personal information included in the image data read from the sensor unit 102 in the image sensor and then outputting the anonymized personal information to the outside of the image sensor, the personal information is not inadvertently exposed to a third party, and the personal information can be reliably protected.

For example, the personal information detection unit 1001 is arranged in the recognition processing unit 104, and the anonymization processing unit 1002 is arranged in the image processing unit 106. Of course, both the personal information detection unit 1001 and the anonymization processing unit 1002 may be arranged in the recognition processing unit 104, or both the personal information detection unit 1001 and the anonymization processing unit 1002 may be arranged in the image processing unit 106.

Furthermore, each of the personal information detection unit 1001 and the anonymization processing unit 1002 may be configured by an individual learned model (convolutional neural network or the like), or may be configured as an E2E (End to End) machine learning model in which the personal information detection unit 1001 and the anonymization processing unit 1002 are integrated.

### D-2. Second Configuration Example

In the configuration example described in item D-1 described above, the anonymization processing unit 1002 may perform a process of applying blindfold, mosaic, or blur as anonymization processing of the person image included in the image data. However, in such simple anonymization processing, attribute information such as race, gender, and age of the original person is missing, and data quality is deteriorated. As a result, there arises a problem that it is not appropriate as learning data of machine learning. Therefore, as a more preferable embodiment, the anonymization processing unit 1002 performs a face conversion process of replacing the person image included in the image data with an another person image having the same attribute information as that of the person. In such a case, the image sensor can supply sensor data in which the personal information is anonymized while maintaining the quality without missing the attribute information and the like, and thus can be used as good learning data of machine learning.

FIG. 11 illustrates a functional configuration example for anonymizing personal information in image data by replacing the personal information with another person information. In the example illustrated in FIG. 11, the process of replacing the person image in the image data with an appropriate another person image is performed by a personal information detection unit 1101, an attribute information detection unit 1102, an another person image generation unit 1103, and a face replacement processing unit 1104. Note that the personal information detection unit 1101 is similar to the personal information detection unit 1001 in FIG. 10. Furthermore, the attribute information detection unit 1102, the another person image generation unit 1103, and the face replacement processing unit 1104 correspond to the anonymization processing unit 1002 in FIG. 10.

When capturing the image data from the sensor unit 102 via the readout unit 711 (described above), the personal information detection unit 1101 detects the person image as the personal information included in the image data.

The attribute information detection unit 1102 detects attribute information of the personal information detected by the personal information detection unit 1101. The attribute information mentioned here is race, gender, age, and the like. Various types of information such as occupation and hometown may be included as necessary.

The another person image generation unit 1103 generates an another person image having the same attribute information as the person image detected from the original image data by the personal information detection unit 1101. Then, the face replacement processing unit 1104 performs anonymization processing by replacing the personal information included in the original image data with the another person image generated by the another person image generation unit 1103.

In this way, by anonymizing the personal information included in the image data read from the sensor unit 102 in the image sensor and then outputting the anonymized personal information to the outside of the image sensor, the personal information is not inadvertently exposed to a third party, and the personal information can be reliably protected. Furthermore, according to the functional configuration illustrated in FIG. 11, the image sensor can supply sensor data in which the personal information is anonymized while maintaining the quality without missing the attribute information and the like, and thus can be used as good learning data of machine learning.

For example, the personal information detection unit 1101, the attribute information detection unit 1102, and the another person image generation unit 1103 are arranged in the recognition processing unit 104, and the face replacement processing unit 1104 is arranged in the image processing unit 106. Of course, the personal information detection unit 1101, the attribute information detection unit 1102, the another person image generation unit 1103, and the face replacement processing unit 1104 may all be arranged in the recognition processing unit 104 or the image processing unit 106.

Furthermore, each of the personal information detection unit 1101, the attribute information detection unit 1102, and the another person image generation unit 1103 may be configured by an individual learned model (convolutional neural network or the like). Alternatively, it may be configured as an E2E machine learning model in which the personal information detection unit 1101, the attribute information detection unit 1102, the another person image generation unit 1103, and the face replacement processing unit 1104 are integrated.

### D-3. Generation of Another Person Image

In order to realize the anonymization of the personal information while maintaining the data quality, the another person image generation unit 1103 needs to generate an another person image whose authenticity cannot be determined from the original person image. Therefore, in the present embodiment, the another person image generation unit 1103 generates the another person image using a generative adversarial network (GAN). The GAN is a method of unsupervised learning in which a generator and a discriminator each constituted by a neural network are caused to compete with each other to deepen learning of input data, and is used for generating non-existent data or converting data according to characteristics of existing data.

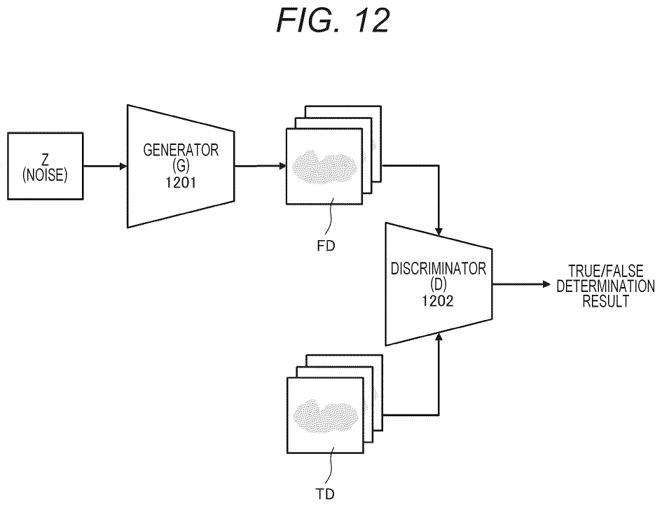

Here, the GAN algorithm will be briefly described with reference to FIG. 12. The GAN uses a generator (G) 1201 and a discriminator (D) 1202. The generator 1201 and the discriminator 1202 are each configured by a neural network model. The generator 1201 adds noise (random latent variable z) to the input image to generate a false image FD (False Data). On the other hand, the discriminator 1202 discriminates true/false of the real image TD (True Data) and the image FD generated by the generator 1201. Then, the generator 1201 learns while competing with the discriminator 1202 such that the generator 1201 makes the discriminator 1202 to hardly discriminate the true/false and on the other hand the discriminator 1202 can correctly discriminate the true/false of the image generated by the generator 1201, whereby the generator 1201 can generate an image in which the true/false determination is impossible.

Specifically, the another person image generation unit 1103 may artificially generate the another person image having the same attribute information as the person image by using StyleGAN2 (see, for example, Non-Patent Document 1) obtained by further improving StyleGAN that realizes high-resolution image generation using Progressive Growing.

### D-4. Processing Procedure

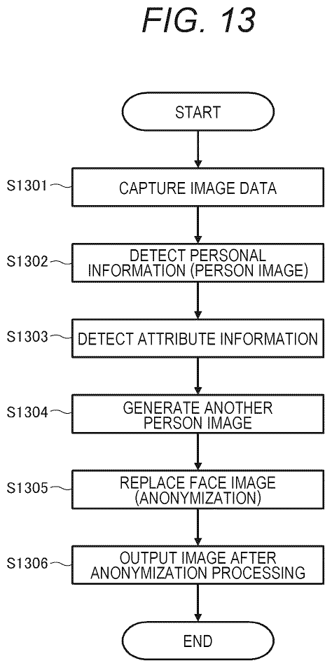

FIG. 13 illustrates a processing procedure for performing anonymization processing of image data captured from the sensor unit 102 in the image sensor having the functional configuration illustrated in FIG. 11 in the form of a flowchart.

First, image data is captured from the sensor unit 102 (step S1301). However, instead of directly capturing the image data from the sensor unit 102, the image data subjected to the visual recognition processing by the image processing unit 106 may be captured.

Next, the personal information detection unit 1101 detects a person image as the personal information included in the image data (step S1302).

Next, the attribute information detection unit 1102 detects attribute information of the personal information detected by the personal information detection unit 1101 (step S1303).

Next, the another person image generation unit 1103 generates an another person image having the same attribute information as the person image detected from the original image data by the personal information detection unit 1101 using, for example, GAN (StyleGAN2) (step S1304).

Then, the face replacement processing unit 1104 performs anonymization processing by replacing the personal information included in the original image data with the another person image generated by the another person image generation unit 1103 (step S1305). The anonymized image data is output to the outside of the image sensor (step S1306), and the present processing is terminated.

### D-5. Modification

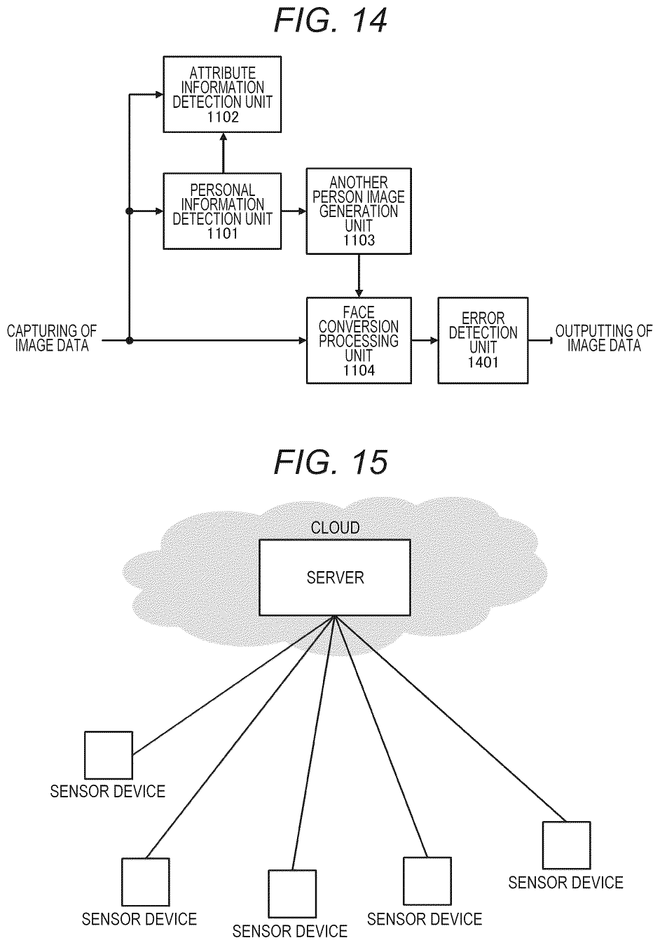

FIG. 14 illustrates a modification of the functional configuration for the anonymization processing illustrated in FIG. 11. In the drawing, the same functional modules as those illustrated in FIG. 11 are denoted by the same names and the same reference numerals, and a detailed description thereof will be omitted here. Specifically, the main difference is that an error detection unit 1401 is added.

The error detection unit 1401 detects an error that has occurred in the process of replacing the person image in the original image data with an another person image. Alternatively, the error detection unit 1401 may detect not the error but the likelihood or the reliability of the inference results in the machine learning models used in the functional modules 1101 to 1104. Then, when detecting an error or when detecting that the likelihood or reliability of inference is low, the error detection unit 1401 feeds back such a detection result to the sensor control unit 103.

The sensor control unit 103 controls a readout speed of image data from the sensor unit 102 on the basis of feedback from the error detection unit 1401. For example, at the time of capturing a moving image, the occurrence of an error or the low likelihood or reliability of inference is considered to be caused by the fact that the replacement processing with an another person image does not catch up with the frame rate. Therefore, the sensor control unit 103 may lower the frame rate from 30 fps (frame per second) at the normal time to about 2 fps on the basis of feedback that an error has occurred or the likelihood or reliability of inference is low.

### INDUSTRIAL APPLICABILITY

The present disclosure has been described in detail with reference to the specific embodiments. However, it is obvious that those skilled in the art can make modifications and substitutions of the embodiment without departing from the scope of the present disclosure.

In this specification, the embodiment in which the present disclosure is applied to the image sensor has been mainly described, but the gist of the present disclosure is not limited thereto. The present disclosure can also be applied to various sensor devices (alternatively, the sensor circuit chip) capable of sensing data that can include personal information, such as voice, handwritten characters, and biological signals, in addition to images. For example, a voice sensor to which the present disclosure is applied can protect personal information included in a voice by identifying attribute information of an utterer of the voice detected from the input voice, generating a spoken voice of another person having the same attribute information, and replacing the spoken voice in the input voice with the spoken voice of another person. Therefore, the sensor device to which the present disclosure is applied can protect the personal information by replacing the personal information included in the sensor data with another personal information having the same attribute information and then outputting the personal information to the outside, and can acquire the data while maintaining the quality without missing the attribute information and the like.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) A sensor device including:
a sensor unit; and
a processing unit that anonymizes personal information included in sensor information acquired by the sensor unit, in which
the sensor unit and the processing unit are mounted in a single semiconductor device.

(2) The sensor device according to (1), in which
the processing unit replaces the personal information included in the sensor information with information of another person.

(3) The sensor device according to any one of (1) or (2), in which
the processing unit detects the personal information from the sensor information, identifies attribute information of the personal information, generates another person information having same attribute information, and replaces the personal information in the sensor information with the another person information.

(4) The sensor device according to any one of (2) or (3), in which
the processing unit generates another person information using a generative adversarial network.

(5) The sensor device according to any one of (1) to (4), in which
the sensor unit is an image sensor, and
the processing unit replaces a person image included in image data captured by the image sensor with an another person image.

(6) The sensor device according to (5), in which
the processing unit identifies attribute information of a person image detected from image data, generates an another person image having same attribute information, and replaces the person image in the image data with the another person image.

(7) The sensor device according to (6), in which
the processing unit generates, from a person image, an another person image having same attribute information including at least one of age, gender, or race.

(8) The sensor device according to any one of (1) to (4), in which
the sensor unit is a voice sensor, and
the processing unit replaces a human spoken voice included in voice data captured by the voice sensor with a spoken voice of an another person.

(9) The sensor device according to (8), in which
the processing unit identifies attribute information of an utterer of a spoken voice detected from voice data, generates a spoken voice of an another person having same attribute information, and replaces the spoken voice in the voice data with the spoken voice of the another person.

(10) The sensor device according to any one of (1) to (9), in which
an output of the sensor information from the sensor unit is controlled on the basis of a processing result or a processing status of the processing unit.

(11) The sensor device according to (10), in which
the sensor unit is an image sensor, and
a frame rate of the sensor unit is controlled on the basis of a processing result or a processing status of the processing unit.

(12) The sensor device according to any one of (1) to (11), in which
the sensor device is a stacked sensor having a multilayer structure in which the plurality of layers of semiconductor chips is stacked, the sensor unit being formed in a first layer and the processing unit being formed in a second layer or a layer further below the second layer.

(13) The sensor device according to any one of (1) to (12), in which
the sensor device is used by being mounted on a fixed point sensor or a mobile object such as a vehicle, and
sensor information in a state after anonymization of personal information is output to an outside of the semiconductor device.

### REFERENCE SIGNS LIST

100 Imaging device
101 Optical unit
102 Sensor unit
103 Sensor control unit
104 Recognition processing unit
105 Memory
106 Image processing unit
107 Output control unit
108 Display unit
601 Pixel array unit
602 Vertical scanning unit
603 AD conversion unit
604 Horizontal scanning unit
605 Pixel signal line
606 Control unit
607 Signal processing unit
610 Pixel circuit
611 AD converter
612 Reference signal generation unit
711 Readout unit
712 Readout control unit
721 Feature amount extraction unit
722 Recognition processing execution unit
731 Image data accumulation control unit
731A Image accumulation unit
732 Image processing execution unit
741 Trigger generation unit
742 Output control execution unit
800 Convolutional neural network
810 Feature amount extractor
820 Discriminator
1001 Personal information detection unit
1002 Anonymization processing unit
1101 Personal information detection unit
1102 Attribute information detection unit
1103 Another person image generation unit
1104 Face replacement processing unit
1201 Generator
1202 Discriminator
1401 Error detection unit

1. A sensor device comprising:
a sensor unit; and
a processing unit that anonymizes personal information included in sensor information acquired by the sensor unit, wherein
the sensor unit and the processing unit are mounted in a single semiconductor device.

2. The sensor device according to claim 1, wherein
the processing unit replaces the personal information included in the sensor information with information of another person.

3. The sensor device according to claim 1, wherein
the processing unit detects the personal information from the sensor information, identifies attribute information of the personal information, generates another person information having same attribute information, and replaces the personal information in the sensor information with the another person information.

4. The sensor device according to claim 2, wherein
the processing unit generates another person information using a generative adversarial network.

5. The sensor device according to claim 1, wherein
the sensor unit is an image sensor, and
the processing unit replaces a person image included in image data captured by the image sensor with an another person image.

6. The sensor device according to claim 5, wherein
the processing unit identifies attribute information of a person image detected from image data, generates an another person image having same attribute information, and replaces the person image in the image data with the another person image.

7. The sensor device according to claim 6, wherein
the processing unit generates, from a person image, an another person image having same attribute information including at least one of age, gender, or race.

8. The sensor device according to claim 1, wherein
the sensor unit is a voice sensor, and
the processing unit replaces a human spoken voice included in voice data captured by the voice sensor with a spoken voice of an another person.

9. The sensor device according to claim 8, wherein
the processing unit identifies attribute information of an utterer of a spoken voice detected from voice data, generates a spoken voice of an another person having same attribute information, and replaces the spoken voice in the voice data with the spoken voice of the another person.

10. The sensor device according to claim 1, wherein
an output of the sensor information from the sensor unit is controlled on a basis of a processing result or a processing status of the processing unit.

11. The sensor device according to claim 10, wherein
the sensor unit is an image sensor, and
a frame rate of the sensor unit is controlled on a basis of a processing result or a processing status of the processing unit.

12. The sensor device according to claim 1, wherein
the sensor device is a stacked sensor having a multilayer structure in which the plurality of layers of semiconductor chips is stacked, the sensor unit being formed in a first layer and the processing unit being formed in a second layer or a layer further below the second layer.

13. The sensor device according to claim 1, wherein
the sensor device is used by being mounted on a fixed point sensor or a mobile object such as a vehicle, and
sensor information in a state after anonymization of personal information is output to an outside of the semiconductor device.
